(19) United States
(12) Patent Application Publication
(10) Pub. No.: US 2022/0016666 A1
(43) Pub. Date: Jan. 20, 2022

(54) FLUID MATERIAL DISCHARGE APPARATUS

(71) Applicant: MITSUBISHI HEAVY INDUSTRIES, LTD., Tokyo (JP)

(72) Inventors: Takashi SHIBUTANI, Tokyo (JP); Masanobu TSUTSUI, Tokyo (JP); Hiroyuki SAITO, Tokyo (JP)

(21) Appl. No.: 17/294,510

(22) PCT Filed: Dec. 24, 2019
(86) PCT No.: PCT/JP2019/050531

§ 371 Date: May 17, 2021

(30) Foreign Application Priority Data
Feb. 15, 2019 (JP) 2019-025838

(51) Int. Cl. B05C 11/10; B05C 5/02

(52) U.S. Cl. CPC B05C 11/10; B05C 5/02

(57) ABSTRACT

A purpose of the present invention is to prevent leakage of a sealant from the rear end side of a plunger in a sealant discharge operation. The sealant discharge apparatus is equipped with a piston that moves axially inside a cartridge and a contact portion, the outer peripheral surface of which has a cylindrical shape, that is provided at the tip of the piston and can contact the inner peripheral surface of a plunger provided in the cartridge housing a sealant, and the contact portion is provided to be movable radially in the piston.

### TECHNICAL FIELD

The present disclosure relates to a fluid material discharge apparatus.

### BACKGROUND ART

During assembly of an aircraft component such as a main wing and a fuselage, a sealant, which is a fluid material, is applied to a contact surface between a plurality of members or a corner formed at an intersection between an end surface of one member and a plate surface of the other member in some cases. The airtightness of the aircraft component is secured by means of the applied sealant.

Generally, a sealant applying operation is performed manually by an operator using a seal gun (sealant discharge apparatus) into which a cartridge accommodating the sealant is loaded. However, since the number of components required for assembly is large, a long time is taken for the applying operation. In addition, since the sealant contains an organic solvent, there is a concern that the organic solvent may affect human bodies. Therefore, performing the sealant applying operation using an automatic applying device has been proposed. The automatic applying device includes a piston that is driven through servo control. When the piston is driven, the sealant is discharged from a nozzle provided at a tip of the cartridge.

PTL 1 below describes configuring a drive mechanism by using a drive mechanism such as an articulated robot so that a sealant is automatically applied.

### CITATION LIST

### Patent Literature

[PTL 1] Japanese Unexamined Patent Application Publication No. 2017-6886

### SUMMARY OF INVENTION

### Technical Problem

Generally, the sealant has a relatively high compressibility and the volume (that is, density) thereof is likely to change with respect to a change in pressure. Therefore, in a case where the piston moves, not only the sealant is discharged from the nozzle but also the volume of the sealant is decreased and there is a high possibility of an increase in internal pressure of the cartridge. As a result, a gap may be formed between a plunger, which is provided at a rear end side of the cartridge and presses the sealant, and an inner surface of the cartridge and the sealant may leak from a rear end side of the plunger without being pressed by the plunger.

The discharge amount of the sealant is adjusted and controlled by means of the amount of movement of the piston. Therefore, if the sealant leaks, sealant discharge amount control performed based on the amount of movement of the piston cannot be established, which causes an error between a target discharge amount and an actual discharge amount. As a result, there is a problem that the film thickness of a sealant layer to be formed and the width of a fillet having a triangular cross section become different from target values and thus the application quality is not stabilized.

If the sealant does not leak from the rear end side of the plunger, the sealant does not adhere to an outer peripheral surface of the tip of the piston when the piston is removed from the cartridge for cartridge replacement or the like. On the other hand, under a condition that the sealant leaks from the rear end side of the plunger, the sealant adheres to the outer peripheral surface of the tip of the piston when the piston is removed from the cartridge. As a result, a cleaning operation of removing the sealant adhering to the outer peripheral surface needs to be performed at the time of cartridge replacement and thus there is a problem that a time taken for the entire step becomes long.

PTL 1 discloses pressing the plunger against the cartridge by means of rubber inflated by air pressure for the purpose of prevention of sealant leakage. However, it is difficult to control a straining force by means of the rubber. In addition, if a straining force is applied more than necessary, there is a problem that resistance received by the piston may increase or the cartridge may burst.

The gap between the plunger and the inner surface of the cartridge is formed even in a case where a piston axis and the central axis of the cartridge are positionally offset from each other. If a straining force is applied in a case where the axes are positionally offset from each other, the imbalance of a straining force with respect to an inner peripheral surface of the cartridge becomes significant, which results in a high possibility of sealant leakage. However, in a case where cartridge replacement is performed frequently, it is difficult to perform positional alignment at high accuracy each time the cartridge replacement is performed because performing positional alignment at high accuracy each time the cartridge replacement is performed takes time and effort.

The present disclosure has been made in view of such circumstances and an object thereof is to provide a fluid material discharge apparatus with which it is possible to prevent a sealant from leaking from a rear end side of a plunger in a sealant discharge operation.

### Solution to Problem

A fluid material discharge apparatus according to the present disclosure includes a piston that moves in an axial direction inside a cartridge and a contact portion that is provided at a tip of the piston and can come into contact with an inner peripheral surface of a plunger provided in the cartridge accommodating a fluid material and of which an outer peripheral surface has a cylindrical shape. The contact portion is provided to be movable in a radial direction at the piston.

According to such a configuration, the piston moves in the axial direction inside the cartridge and presses on the fluid material accommodated in the cartridge. The pressed fluid material is discharged to the outside from a nozzle provided on the tip side of the cartridge. The contact portion, of which the outer peripheral surface has cylindrical shape, is provided at the tip of the piston and the contact portion can come into contact with the inner peripheral surface of the plunger provided in the cartridge. In addition, the contact portion is provided to be movable in the radial direction at the piston. Accordingly, the central axis of the contact portion is positioned to match the central axis of the cartridge when the piston presses the plunger even in a case where the axis of the piston and the central axis of the cartridge are positionally offset from each other. As a result, a straining force that is generated by the contact portion is generated to be substantially even in a circumferential direction and thus a gap between the plunger and the inner surface of the cartridge is less likely to be formed.

In the above-described fluid material discharge apparatus according to the disclosure, a shaft portion that protrudes in the axial direction may be provided at the tip of the piston, the contact portion may be an annular member, and the shaft portion may be inserted with respect to an inner peripheral surface of the contact portion.

According to such a configuration, the shaft portion that protrudes at the tip of the piston is inserted with respect to the inner peripheral surface of the contact portion, which is an annular member. Since the contact portion is installed around the shaft portion of the piston with a gap provided between the inner peripheral surface of the contact portion and an outer peripheral surface of the shaft portion, the contact portion is movable in the radial direction at the piston.

In the above-described fluid material discharge apparatus according to the disclosure, an outer diameter of the contact portion may be larger than an inner diameter of the plunger and smaller than an inner diameter of the cartridge.

According to such a configuration, when the contact portion comes into contact with the inner peripheral surface of the plunger, the plunger can be expanded outward and thus the plunger can be reliably pressed against the inner peripheral surface of the cartridge. Accordingly, a gap between the plunger and an inner surface of the cartridge is less likely to be formed. In addition, since the outer diameter of the contact portion is slightly larger than the inner diameter of the plunger, a problem that excessive piston resistance may be generated and the cartridge may burst does not occur.

In the above-described fluid material discharge apparatus according to the disclosure, the contact portion may be formed of metal or synthetic resin.

According to such a configuration, the contact portion has a favorable slipperiness and thus the contact portion is easily inserted into the plunger and is reliably installed inside the plunger.

In the above-described fluid material discharge apparatus according to the disclosure, a through-hole may be formed at the tip of the piston and a gas may be able to be sucked through the through-hole.

According to such a configuration, a gas outside the piston can be sucked via the through-hole formed at the tip of the piston. Therefore, when the tip of the piston is inserted into the plunger, a gas in a space between the piston and the plunger is sucked and thus the contact portion and the plunger can be brought into close contact with each other.

### Advantageous Effects of Invention

According to the present disclosure, it is possible to prevent a sealant from leaking from a rear end side of a plunger in a sealant discharge operation and thus it is possible to stabilize the discharge amount of the sealant and to improve the application quality.

### BRIEF DESCRIPTION OF DRAWINGS

FIG. 1 is a schematic configuration view showing a sealant discharge apparatus according to an embodiment of the present disclosure.

FIG. 2 is a vertical sectional view showing a cylinder and a plunger of a cartridge of the sealant discharge apparatus according to the embodiment of the present disclosure.

FIG. 3 is a perspective view showing the cylinder of the sealant discharge apparatus according to the embodiment of the present disclosure.

FIG. 4 is a partially enlarged vertical sectional view showing the cartridge.

FIG. 5 is a vertical sectional view showing a cylinder and a plunger of a cartridge of a sealant discharge apparatus in the related art.

### DESCRIPTION OF EMBODIMENTS

Hereinafter, an embodiment according to the present disclosure will be described with reference to the drawings.

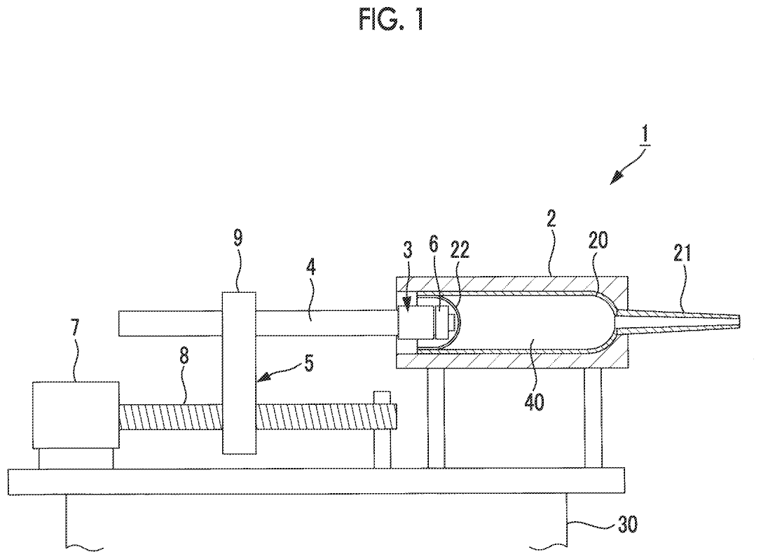

The configuration of a sealant discharge apparatus according to the embodiment of the present disclosure will be described with reference to FIG. 1.

As shown in FIG. 1, the sealant discharge apparatus 1 according to the present embodiment includes a cartridge fixation portion 2, a piston 3, a piston rod 4, a piston drive unit 5, and the like. For example, the sealant discharge apparatus 1 is used in a case where a sealant 40 is to be applied to a contact surface between a plurality of members or a corner formed at an intersection between an end surface of one member and a plate surface of the other member during assembly of an aircraft component such as a main wing and a fuselage.

Regarding the sealant discharge apparatus 1, when a cartridge 20 is fixed to the cartridge fixation portion 2 and the piston 3 presses the sealant 40 accommodated in the cartridge 20, the sealant 40 is discharged from a nozzle 21 provided on a tip side of the cartridge 20.

The sealant discharge apparatus 1 is installed in a drive device 30 such as a robot and is moved by the drive device 30. Since the movement of the sealant discharge apparatus 1 is controlled, the sealant 40 can be discharged to a position to which the sealant 40 needs to be applied.

The cartridge 20 is a cylindrical member and can accommodate the sealant 40. The cartridge 20 may be, for example, a commercially available product. The nozzle 21 is provided at one end (tip side) of the cartridge 20, and the sealant 40 is discharged through the nozzle 21. When the sealant 40 is accommodated inside, a plunger 22 is disposed inside the other end (rear end side) of the cartridge 20. The plunger 22 has, for example, a substantially U-shaped vertical section and has a shape obtained combining a cylindrical member and a hemispherical member with each other. The plunger 22 is installed inside the cartridge 20 such that a bottom portion thereof is positioned on the tip side of the cartridge 20 and a circular edge portion thereof is positioned on the rear end side of the cartridge 20.

The plunger 22 can accommodate a tip of the piston 3 and when the plunger 22 is pressed by the piston 3, the plunger 22 moves along an axial direction of the cartridge 20. When the plunger 22 moves and presses the sealant 40, the sealant 40 is discharged from the nozzle 21.

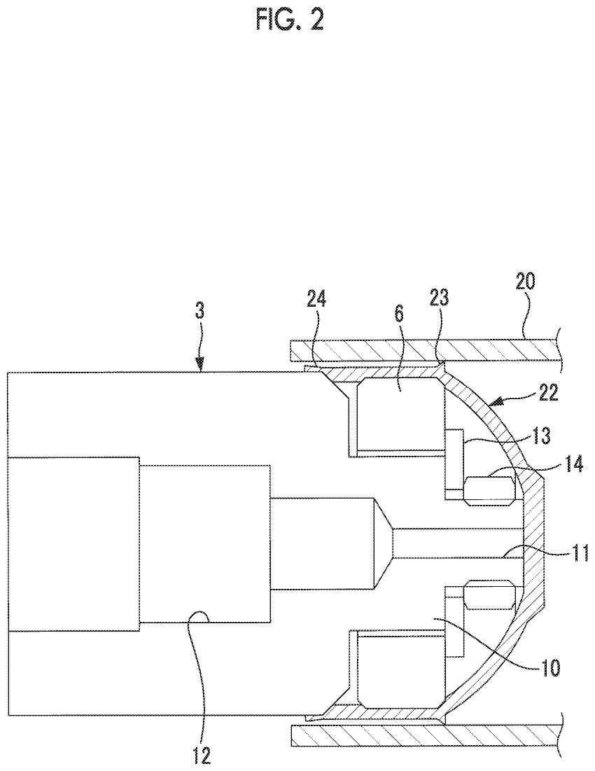

As shown in FIGS. 2 and 4, a sealing lip 23 is provided on an outer peripheral surface of a cylindrical portion of the plunger 22. The sealing lip 23 is provided in an annular shape along a circumferential direction of the cylindrical portion and is formed to protrude in an outward direction. The sealing lip 23 can come into contact with an inner peripheral surface of the cartridge 20. The sealing lip 23 prevents the sealant 40 from leaking to the outside.

A dust wiper 24 is formed on an edge portion of the plunger 22. The dust wiper 24 has a tapered shape of which the diameter increases toward the edge portion of the plunger 22 from the bottom portion of the plunger 22. A tip of the dust wiper 24, that is, the edge portion of the plunger 22, can come into contact with the inner peripheral surface of the cartridge 20. The dust wiper 24 prevents a foreign substance (for example, dust) from entering the cartridge 20.

The cartridge fixation portion 2 has, a configuration in which the cartridge 20 can be accommodated inside and the cartridge 20 accommodated inside therein is fixed such that the cartridge 20 is not moved. The cartridge fixation portion 2 is connected to the drive device 30 such as a robot.

The piston 3 is provided to move in the axial direction inside the cartridge 20 accommodated in the cartridge fixation portion 2. The piston 3 is a cylindrical member and is installed integrally with the piston rod 4 at a tip of the rod-shaped piston rod 4. A contact portion 6, which will be described later, is provided at the tip of the piston 3.

The piston rod 4 is connected to the piston drive unit 5 and is moved by the piston drive unit 5. With the movement of the piston 3 in the axial direction controlled via the piston rod 4, the position of the piston 3 in the cartridge 20 and the amount of movement of the piston 3 are adjusted. The discharge amount of the sealant 40 is adjusted and controlled by means of the amount of movement of the piston 3.

The piston drive unit 5 is connected to the piston rod 4 and moves the piston rod 4 in parallel with the axial direction of the cartridge 20. The piston drive unit 5 includes, for example, a servomotor 7, a feed screw 8, a bracket 9, and the like. The servomotor 7 is connected to the feed screw 8 and causes the feed screw 8 to rotate around an axis. The feed screw 8 is connected to the bracket 9 coupled to the piston rod 4 and the bracket 9 is moved in parallel with the axial direction when the feed screw 8 rotates around the axis. The servomotor 7 and the feed screw 8 of the piston drive unit 5 are connected to the drive device 30 such as a robot.

Since the servomotor 7, the feed screw 8, and the cartridge fixation portion 2 are fixed to the drive device 30 and the piston 3 and the piston rod 4 are configured to be movable, it is possible to discharge the sealant 40 accommodated in the cartridge 20 fixed to the cartridge fixation portion 2 by driving the piston 3.

As shown in FIGS. 1 to 3, the contact portion 6 of which an outer peripheral surface has a cylindrical shape is provided at the tip of the piston 3. The contact portion 6 can come into contact with an inner peripheral surface of the plunger 22 provided in the cartridge 20.

As shown in FIG. 2, a shaft portion 10 protruding in the axial direction is provided at the tip of the piston 3. The shaft portion 10 has a cylindrical shape smaller than the diameter of the piston 3. The contact portion 6 is an annular member, and the shaft portion 10 is inserted with respect to an inner peripheral surface of the contact portion 6. The outer diameter of the shaft portion 10 is smaller than the inner diameter of the contact portion 6 with a fitting structure in which a gap is formed between an outer peripheral surface of the shaft portion 10 and the inner peripheral surface of the contact portion 6.

Accordingly, the contact portion 6 is provided to be movable (slidable) in a radial direction at the piston 3. With such a structure, the central axis of the contact portion 6 is positioned to match the central axis of the cartridge 20 when the piston 3 presses the plunger 22 even in a case where the axis of the piston 3 and the central axis of the cartridge 20 are positionally offset from each other. As a result, a straining force that is generated by the contact portion 6 with respect to an inner surface of the cartridge 20 is generated to be substantially even in the circumferential direction and thus a gap between the plunger 22 and the inner surface of the cartridge 20 is less likely to be formed.

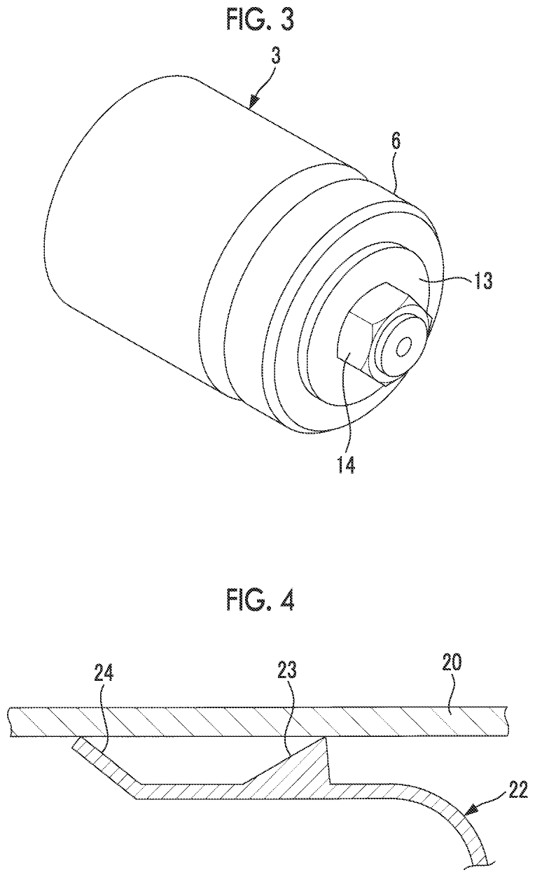

As shown in FIGS. 2 and 3, the contact portion 6 having an annular shape is restrained from falling off in the axial direction by, for example, a disk 13 and a bolt 14. The disk 13 is installed on the tip side of the piston 3 to be adjacent with the contact portion 6. The bolt 14 is fixed at the tip of the piston 3 such that the disk 13 is interposed between the contact portion 6 and the bolt 14.

Note that, the configuration of the contact portion 6 is not limited to that in the above-described example and the contact portion 6 may have a different configuration as long as the contact portion 6 is a member of which an outer peripheral surface has a cylindrical shape and is provided to be movable in the radial direction at the piston 3. For example, the contact portion 6 may be provided with a shaft portion protruding in the axial direction and the shaft portion may be inserted into a recessed portion provided at the center portion of the piston 3. In this case, the outer diameter of the shaft portion is made smaller than the inner diameter of the recessed portion such that the contact portion 6 can move in the radial direction at the piston 3.

The outer diameter of the contact portion 6 is larger than the inner diameter of the plunger 22 and smaller than the inner diameter of the cartridge 20. Accordingly, when the contact portion 6 comes into contact with the inner peripheral surface of the plunger 22, the plunger 22 can be expanded outward and thus the plunger 22 can be reliably pressed against the inner peripheral surface of the cartridge 20. As a result, a gap between the plunger 22 and the inner surface of the cartridge 20 is less likely to be formed. In addition, since the outer diameter of the contact portion 6 is slightly larger than the inner diameter of the plunger, a problem that excessive piston. resistance may be generated and the cartridge 20 may burst does not occur.

It is desirable that the outer peripheral surface of the contact portion 6 is disposed on a back surface side of the sealing lip 23 formed on the cartridge 20 when the contact portion 6 is pressed against the inner peripheral surface of the plunger 22. Since the sealing lip 23 protruding in the outward direction at the outer peripheral surface of the plunger 22 is expanded in the outward direction, a gap between the plunger 22 and the inner surface of the cartridge 20 can be sealed. Accordingly, when the contact portion 6 comes into contact with the inner peripheral surface of the plunger 22, the sealing lip 23 can be expanded outward and thus the sealing lip 23 of the plunger 22 can be reliably pressed against the inner peripheral surface of the cartridge 20. As a result, a gap between the plunger 22 and the inner surface of the cartridge 20 is less likely to be formed.

The contact portion 6 is formed of, for example, metal (for example, stainless steel, steel, or like) or synthetic resin (for example, polytetrafluoroethylene (PTFE), or like). Accordingly, the contact portion 6 has a favorable slipperiness and thus the contact portion 6 is easily inserted into the plunger 22 and is reliably installed inside the plunger 22.

When the tip of the piston 3 is inserted into the plunger 22 for installation, a space formed in a gap between the piston 3 and the plunger 22 is sealed, and air (gas) is compressed. Therefore, it is desirable that the air accumulated in the space is discharged to the outside. For example, the tip of the piston 3 may be provided with a through-hole 11 so that the air is discharged to the outside through a flow channel 12 penetrating the piston 3 in the axial direction. In addition, connecting the flow channel 12 and a vacuum pump (not shown) to each other may also be adopted in addition to simply making the air open to the outside air. Accordingly, the through-hole 11 formed at the tip of the piston 3 serves as a vacuum suction mechanism and thus a gas outside the piston 3 can be sucked. As a result, when the tip of the piston 3 is inserted into the plunger 22, the air in the space between the piston 3 and the plunger 22 is sucked and thus the contact portion 6 and the plunger 22 can be brought into close contact with each other more reliably.

Next, a method of discharging a sealant by using the sealant discharge apparatus 1 according to the present embodiment will be described.

First, the cartridge 20 into which the sealant 40 to be discharged is accommodated is prepared. Then, the cartridge 20 is fixed to the cartridge fixation portion 2 of the sealant discharge apparatus 1.

At this time, the piston 3 of the sealant discharge apparatus 1 is inserted into the plunger 22 of the fixed cartridge 20 and is installed therein. The contact portion 6 provided at the tip of the piston 3 is provided to be movable in the radial direction at the piston 3. Therefore, the central axis of the contact portion 6 is positioned to match the central axis of the plunger 22, that is, the cartridge 20 when the piston 3 presses the plunger 22 and the contact portion 6 is inserted into the plunger 22 even in a case where the axis of the piston 3 and the central axis of the cartridge 20 are positionally offset from each other. In addition, the outer diameter of the contact portion 6 is larger than the inner diameter of the plunger 22 and smaller than the inner diameter of the cartridge 20. Accordingly, when the contact portion 6 comes into contact with. the inner peripheral surface of the plunger 22, the plunger 22 is expanded outward and thus the plunger 22 is reliably pressed against the inner peripheral surface of the cartridge 20.

In addition, in a case where the through-hole 11 formed at the tip of the piston 3 can serve as a vacuum suction mechanism, the vacuum pump may be driven when the contact portion 6 is inserted into the plunger 22 so that air in a space between the piston 3 and the plunger 22 is sucked. As a result, the contact portion 6 and the plunger 22 can be brought into close contact with each other more reliably.

Next, the sealant discharge apparatus 1 to which the cartridge 20 is fixed is moved to a position facing an object (aircraft component or like) to which the sealant 40 is to be applied. Alternatively, the object is moved to an operation position of the sealant discharge apparatus 1.

In an operation of applying the sealant 40, the servomotor 7 is driven and the piston 3 is moved such that the sealant 40 is discharged from the nozzle 21 in accordance with the amount of movement of the piston 3. At this time, a discharge amount is adjusted in accordance with the amount of the sealant 40 required to be applied to the object. When the required amount of the sealant 40 is discharged, the movement of the piston 3 is stopped.

Then, a discharge operation is repeated at a place where the sealant 40 needs to be applied to the object. In a case where the sealant 40 accommodated in the cartridge 20 is emptied or the amount thereof is small, the cartridge 20 is replaced. In a case the cartridge 20 is to be removed, the piston 3 is moved in a direction opposite to a direction in which the piston 3 is moved at the time of discharge and then. the cartridge 20 is unfixed from the cartridge fixation portion 2 so that the cartridge 20 is removed. Then, the cartridge 20 is fixed to the cartridge fixation portion 2 again in the same manner as the above-described method.

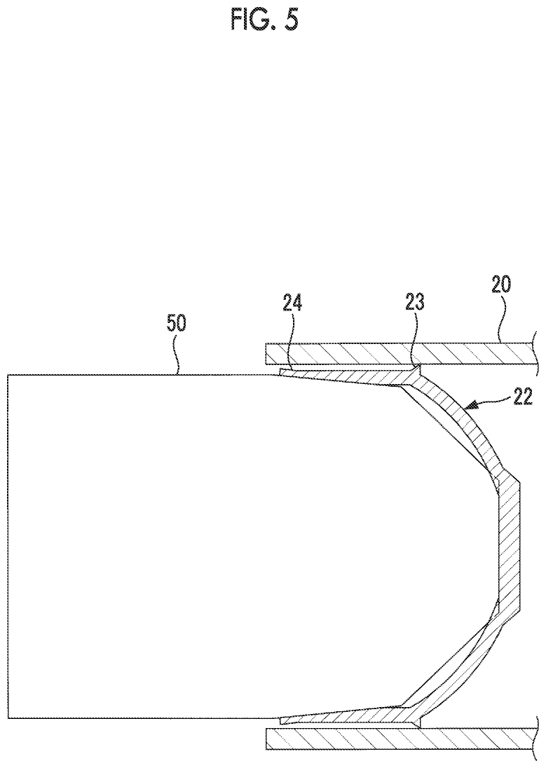

In the related art, a piston 50 in a sealant discharge apparatus is one member having a substantially cylindrical shape as shown in FIG. 5. Therefore, in a case where the axis of the piston and the central axis of the cartridge 20 are positionally offset from each other, the plunger 22 unevenly applies a straining force with respect to the inner peripheral surface of the cartridge 20. Therefore, to prevent a sealant from leaking to a rear end side of the plunger 22, it is necessary to positionally align the axis of the piston 3 and the central axis of the cartridge 20 with each other.

On the other hand, according to the present embodiment, the contact portion 6 of which the outer peripheral surface has a cylindrical shape is provided at the tip of the piston 3 and the contact portion 6 can come into contact with the inner peripheral surface of the plunger 22 provided in the cartridge 20 as shown in FIG. 2. In addition, the contact portion 6 is provided to be movable in the radial direction at the piston 3. Accordingly, the central axis of the contact portion 6 is positioned to match the central axis of the cartridge 20 when the piston 3 presses the plunger 22 even in a case where the axis of the piston 3 and the central axis of the cartridge 20 are positionally offset from each other.

Therefore, even in a case where the axis of the piston 3 and the central axis of the cartridge 20 are positionally offset from each other, it is not necessary to positionally align the axis of the piston 3 and the central axis of the cartridge 20 with each other and the central axis of the contact portion 6 coincides with the central axis of the cartridge 20 since the contact portion 6 moves in the radial direction.

As a result, even in a case where the axis of the piston 3 and the central axis of the cartridge 20 are positionally offset from each other, the straining force generated by the contact portion 6 is substantially even in the circumferential direction and thus a gap between the plunger 22 and the inner surface of the cartridge 20 is less likely to be formed unlike the piston in the related art which is not provided with the contact portion 6.

In addition, the outer diameter of the contact portion 6 is larger than the inner diameter of the plunger 22 and smaller than the inner diameter of the cartridge 20. Accordingly, when the contact portion 6 comes into contact with the inner peripheral surface of the plunger 22, the plunger 22 can be expanded outward and thus the plunger 22 can be reliably pressed against the inner peripheral surface of the cartridge 20. Accordingly, a gap between the plunger 22 and the inner surface of the cartridge 20 is less likely to be formed. In addition, since the outer diameter of the contact portion 6 is smaller than the inner diameter of the cartridge 20, a problem that resistance received by the piston 3 may be increased or the cartridge 20 may burst does not occur.

It is desirable that the contact portion 6 is formed of metal or synthetic resin and it is desirable that the through-hole 11 is formed at the tip of the piston 3 and a gas can be sucked via the through-hole 11. Accordingly, the contact portion 6 is reliably installed in the plunger 22.

Accordingly, a gap between the plunger 22 and the inner surface of the cartridge 20 is less likely to be formed and thus the sealant 40 is prevented from leaking from the rear end side of the plunger 22 in an operation of discharging the sealant 40 in the sealant discharge apparatus 1. In addition, since a discharge amount is stable, the application quality of the sealant 40 is improved. In addition, since the sealant 40 does not adhere to the outer peripheral surface of the tip of the piston 3 when the piston. 3 is removed from the cartridge 20, it is not necessary to perform a cleaning operation of removing the sealant 40 adhering thereto.

Note that, in the above-described embodiment, a case where a material to be discharged is a sealant has been described. However, the present disclosure is not limited to this example and can be applied to a fluid material other than the sealant. For example, the fluid material may be synthetic resin such as an adhesive agent, or oils and fats such as grease or a rust preventive agent.

### REFERENCE SIGNS LIST

1: sealant discharge apparatus

2: cartridge fixation portion

3: piston

4: piston rod

5: piston drive unit

6: contact portion

7: servomotor

8: feed screw

9: bracket

10: shaft portion

11: through-hole

12: flow channel

13: disk

14: bolt

20: cartridge

21: nozzle

22: plunger

23: sealing lip

24: dust wiper

30: drive device

40: sealant

50: piston

1. A fluid material discharge apparatus comprising:
a piston that moves in an axial direction inside a cartridge; and
a contact portion that is provided at a tip of the piston and can come into contact with an inner peripheral surface of a plunger provided in the cartridge accommodating a fluid material and of which an outer peripheral surface has a cylindrical shape,
wherein the contact portion is provided to be movable in a radial direction at the piston.

2. The fluid material discharge apparatus according to claim 1,
wherein a shaft portion that protrudes in the axial direction is provided at the tip of the piston, and
the contact portion is an annular member and the shaft portion is inserted with respect to an inner peripheral surface of the contact portion.

3. The fluid material discharge apparatus according to claim 1,
wherein an outer diameter of the contact portion is larger than an inner diameter of the plunger and smaller than an inner diameter of the cartridge.

4. The fluid material discharge apparatus according to claim 1,
wherein the contact portion is formed of metal or synthetic resin.

5. The fluid material discharge apparatus according to claim 1,
wherein a through-hole is formed at the tip of the piston and a gas can be sucked through the through-hole.
